(19) United States
(12) Patent Application Publication
(10) Pub. No.: US 2025/0035329 A1
(43) Pub. Date: Jan. 30, 2025

(54) ROOM AREA ACQUISITION METHOD, AIR CONDITIONER OUTDOOR UNIT CONTROL METHOD, APPARATUS AND AIR CONDITIONING SYSTEM

(71) Applicant: GREE ELECTRIC APPLIANCES, INC. OF ZHUHAI, Zhuhai (CN)

(72) Inventors: Kai DU, Zhuhai (CN); Hongliang ZOU, Zhuhai (CN); Dongbiao WEN, Zhuhai (CN); Zhifeng LI, Zhuhai (CN); Fan WU, Zhuhai (CN)

(73) Assignee: GREE ELECTRIC APPLIANCES, INC. OF ZHUHAI, Zhuhai (CN)

(21) Appl. No.: 18/916,580

(22) Filed: Oct. 15, 2024

Related U.S. Application Data
(63) Continuation of application No. PCT/CN2022/137263, filed on Dec. 7, 2022.

(30) Foreign Application Priority Data
May 25, 2022 (CN) 202210573208.7

(51) Int. Cl. F24F 11/63

(52) U.S. Cl. CPC F24F 11/63

(57) ABSTRACT

A room area acquisition method includes: setting a room area initial value according to an air conditioner model parameter; acquiring a stable operation duration and a number of stop times of an air conditioner outdoor unit from starting up and stable operation to stopping at a temperature point; estimating a deviation between the room area initial value and a room area actual value according to the stable operation duration and the number of stop times, and outputting a deviation result; adjusting the room area initial value according to the deviation result, and performing estimation again according to an adjusted room area value; and taking the current room area value as the room area actual value when a deviation result output by current estimation is different from a deviation result output by last estimation.

### CROSS-REFERENCE TO RELATED APPLICATIONS

The present application is a continuation of International Application No. PCT/CN2022/137263, filed on Dec. 7, 2022, which claims priority to Chinese Patent Application No. 202210573208.7, filed on May 25, 2022. All of the aforementioned patent applications are hereby incorporated by reference in their entireties.

### TECHNICAL FIELD

The present disclosure relates to a room area acquisition method, an air conditioner outdoor unit control method, a room area acquisition apparatus, an air conditioner outdoor unit control apparatus, and an air conditioning system.

### BACKGROUND

In an air conditioning control method known to the inventors, an outdoor unit acquires data such as indoor ambient temperature, set temperature, and indoor unit pipe temperature, and adjusts control parameters of the outdoor unit based on these data.

### SUMMARY

In order to overcome, at least to a certain extent, a problem that an operating power of an outdoor unit of an air conditioner does not match an indoor demand due to a fact that the indoor and outdoor units of the air conditioner cannot communicate in time, embodiments of the present disclosure provide a room area acquisition method, an air conditioner outdoor unit control method, a room area acquisition apparatus, an air conditioner outdoor unit control apparatus, and an air conditioning system.

According to a first aspect, embodiments of the present disclosure provide a room area acquisition method, which includes:
setting a room area initial value according to an air conditioner model parameter;
acquiring a stable operation duration and a number of stop times of an air conditioner outdoor unit from starting up and stable operation to stopping at a temperature point;
estimating a deviation between the room area initial value and a room area actual value according to the stable operation duration and the number of stop times, and outputting a deviation result, where the deviation result includes: a current room area value is relatively large or a current room area value is relatively small;
adjusting the room area initial value according to the deviation result, and performing estimation again according to an adjusted room area value; and
taking the current room area value as the room area actual value when a deviation result output by current estimation is different from a deviation result output by last estimation.

In some embodiments, when the stable operation duration is larger than a preset stable operation duration threshold, the deviation result is that the current room area value is relatively small.

In some embodiments, when the stable operation duration is less than a preset stable operation duration threshold, and the number of stop times is not less than a preset number of times, and a difference between a current stable operation duration and a last stable operation duration is less than a preset duration difference, the deviation result is that the current room area value is relatively large.

In some embodiments, the adjusting the room area initial value according to the deviation result includes:
increasing a room area according to a preset first step value when the deviation result is that the current room area value is relatively small.

In some embodiments, the adjusting the room area initial value according to the deviation result includes:
reducing a room area according to a preset second step value when the deviation result is that the current room area value is relatively large.

In some embodiments, the room area acquisition method further includes:
determining whether a difference between the room area actual value and the room area initial value is larger than a preset area difference; and
in a case that the difference between the room area actual value and the room area initial value is larger than the preset area difference, when a user shutdown is detected, setting the room area initial value according to the air conditioner model parameter.

In some embodiments, the room area acquisition method further includes:
in a case that the difference between the room area actual value and the room area initial value is less than or equal to the preset area difference, when a user shutdown is detected, setting the room area actual value as the room area initial value.

In some embodiments, acquiring the stable operation duration of the air conditioner outdoor unit from starting up and stable operation to stopping at the temperature point includes:
acquiring a first time point at which the stable operation is reached after the air conditioner outdoor unit is started up;
acquiring a second time point at which a stop signal is received after the stable operation of the air conditioner outdoor unit; and
taking a time difference between the second time point and the first time point as the stable operation duration of the air conditioner outdoor unit from starting up and stable operation to stopping at the temperature point.

In some embodiments, the room area acquisition method further includes:
determining that a startup-shutdown control is abnormal when a number of times of receiving the stop signal within a preset time exceeds a preset number of times threshold.

In some embodiments, the room area acquisition method further includes:
when the room area is increased to reach a preset room area upper limit value, and the deviation result is that the current room area value is relatively small, taking the room area upper limit value as the room area actual value.

In some embodiments, the room area acquisition method further includes:
when the room area is reduced to reach a preset room area lower limit value, and the deviation result is that the current room area value is relatively large, taking the room area lower limit value as the room area actual value.

In some embodiments, the air conditioner model parameter includes a refrigerating capacity of an air conditioner.

According to a second aspect, embodiments of the present disclosure provide an air conditioner outdoor unit control method, which includes:
acquiring a room area actual value according to the room area acquisition method according to any one of the foregoing embodiments; and
controlling an air conditioner operation parameter of the air conditioner outdoor unit according to the room area actual value.

In some embodiments, the air conditioner operation parameter includes:
at least one of a frequency of a compressor and a rotational speed of an external fan.

According to a third aspect, embodiments of the present disclosure provide a room area acquisition apparatus, which includes:
a setting module, configured to set a room area initial value according to an air conditioner model parameter;
a first acquiring module, configured to acquire a stable operation duration and a number of stop times of an air conditioner outdoor unit from starting up and stable operation to stopping at a temperature point;
an estimating module, configured to estimate a deviation between the room area initial value and a room area actual value according to the stable operation duration and the number of stop times, and output a deviation result, where the deviation result includes: a current room area value is relatively large or a current room area value is relatively small;
an adjusting module, configured to adjust the room area initial value according to the deviation result, and perform estimation again according to an adjusted room area value; and
an outputting module, configured to take the current room area value as the room area actual value when a deviation result output by current estimation is different from a deviation result output by last estimation.

According to a fourth aspect, embodiments of the present disclosure provide an air conditioner outdoor unit control apparatus, which includes:
a second acquiring module, configured to acquire a room area actual value according to the room area acquisition method according to the first aspect; and
a controlling module, configured to control an air conditioner operation parameter of the air conditioner outdoor unit according to the room area actual value.

According to a fifth aspect, embodiments of the present disclosure provide a room area acquisition apparatus, which includes: a memory; and a processor coupled to the memory and configured to perform the room area acquisition method according to any one of the foregoing embodiments based on instructions stored in the memory.

According to a sixth aspect, embodiments of the present disclosure provide an air conditioner outdoor unit control apparatus, which includes: a memory; and a processor coupled to the memory and configured to perform the air conditioner outdoor unit control method according to any one of the foregoing embodiments based on instructions stored in the memory.

According to a seventh aspect, embodiments of the present disclosure provide an air conditioner outdoor unit, which includes:
the room area acquisition apparatus according to any one of the foregoing embodiments, and/or, the air conditioner outdoor unit control apparatus according to any one of the foregoing embodiments.

According to an eighth aspect, embodiments of the present disclosure provide an air conditioning system, which includes:
the air conditioner outdoor unit according to any one of the foregoing embodiments, a temperature controller, and an air conditioner indoor unit;
where the temperature controller is configured to control the air conditioner outdoor unit to start up or shut down; and
the air conditioner outdoor unit is configured to drive the air conditioner indoor unit to perform cooling or heating on a room where the air conditioner indoor unit is located.

According to a ninth aspect, embodiments of the present disclosure provide a computer-readable storage medium, which includes: computer program instructions, where when the computer program instructions are executed by a processor, the method according to any one of the foregoing embodiments is implemented.

According to a tenth aspect, embodiments of the present disclosure provide a computer program product, which includes: a computer program, where when the computer program is executed by a processor, the method according to any one of the foregoing embodiments is implemented.

Technical solutions provided in the embodiments of the present disclosure may include the following beneficial effects.

The room area acquisition method, the air conditioner outdoor unit control method, an apparatus, and the air conditioning system are provided by the embodiments of the present disclosure. The room area acquisition method includes: setting a room area initial value according to an air conditioner model parameter; acquiring a stable operation duration and a number of stop times of an air conditioner outdoor unit from starting up and stable operation to stopping at a temperature point; estimating a deviation between the room area initial value and a room area actual value according to the stable operation duration and the number of stop times, and outputting a deviation result, where the deviation result includes: a current room area value is relatively large or a current room area value is relatively small; adjusting the room area initial value according to the deviation result, and performing estimation again according to an adjusted room area value; and taking the current room area value as the room area actual value when a deviation result output by current estimation is different from a deviation result output by last estimation. In this way, a room area may be accurately acquired under a condition that indoor and outdoor units cannot communicate, and then an operation parameter of the outdoor unit may be adjusted according to the room area, thereby solving the problem that the power of the outdoor unit does not match the indoor demand, improving the user experience and an operation stability of the outdoor unit.

It should be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the present disclosure, and are used to explain the principles of the present disclosure in conjunction with this specification.

FIG. 1 is a flowchart of a room area acquisition method according to some embodiments of the present disclosure.

FIG. 2 is a flowchart of a room area acquisition method according to some other embodiments of the present disclosure.

FIG. 3 is a flowchart of a room area acquisition method according to some other embodiments of the present disclosure.

FIG. 4 is a flowchart of an air conditioner outdoor unit control method according to some embodiments of the present disclosure.

FIG. 5 is a functional structural diagram of a room area acquisition apparatus according to some embodiments of the present disclosure.

FIG. 6 is a functional structural diagram of an air conditioner outdoor unit control apparatus according to some embodiments of the present disclosure.

### DETAILED DESCRIPTION OF THE EMBODIMENTS

In order to make objectives, technical solutions, and advantages of the present disclosure clearer, the technical solutions of the present disclosure will be described in detail below. Apparently, the described embodiments are merely some but not all of the embodiments of the present disclosure. All other implementations obtained by a person of ordinary skill in the art based on the embodiments of the present disclosure without creative efforts shall fall within the protection scope of the present disclosure.

The inventors note that in some application scenarios, such as different manufacturers or models of an air conditioner indoor unit and an air conditioner outdoor unit, data communication between the air conditioner indoor unit and the air conditioner outdoor unit cannot be carried out, and the air conditioner outdoor unit cannot acquire indoor data, and can only implement startup-shutdown control depending on a startup-shutdown level signal of the outdoor unit provided by a temperature controller. In this case, the air conditioner outdoor unit cannot acquire the indoor data and can only operate according to a fixed control mode, such as fixed power, which may cause that a power of the air conditioner outdoor unit does not match an indoor demand. If the power of the outdoor unit is less than the indoor demand, a continuous operation time of an air conditioner may be relatively long, which affects user experience. If the power of the outdoor unit is larger than the indoor demand, the air conditioner outdoor unit may be frequently started up and stopped, which affects an energy efficiency of the air conditioner.

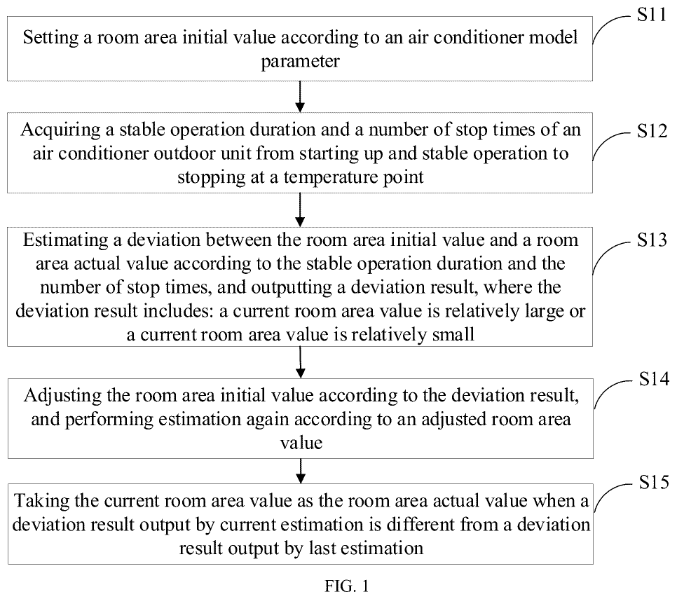

FIG. 1 is a flowchart of a room area acquisition method according to some embodiments of the present disclosure, and as shown in FIG. 1, the room area acquisition method includes steps S11 to S15.

S11: setting a room area initial value according to an air conditioner model parameter.

In some embodiments, the air conditioner model parameter includes a refrigerating capacity of an air conditioner. A current room area value is the room area initial value after the room area initial value is set.

S12: acquiring a stable operation duration and a number of stop times of an air conditioner outdoor unit from starting up and stable operation to stopping at a temperature point.

S13: estimating a deviation between the room area initial value and a room area actual value according to the stable operation duration and the number of stop times, and outputting a deviation result, where the deviation result includes: a current room area value is relatively large or a current room area value is relatively small.

It should be understood that the step of estimating a deviation between the room area initial value and a room area actual value, is a step of, estimating a deviation between a current room area value and the room area actual value.

S14: adjusting the room area initial value according to the deviation result, and performing estimation again according to an adjusted room area value.

It should be understood that if the deviation result output by S13 is that the current room area value is relatively large, the room area initial value is reduced in step S14; and if the deviation result output by S13 is that the current room area value is relatively small, the room area initial value is increased in step S14.

After the room area initial value is adjusted, the current room area value is an adjusted room area value. The deviation between the adjusted room area value and the room area actual value is re-estimated according to the stable operation duration and the number of stop times, then the deviation result is output. In other words, step S13 is repeatedly performed by taking the adjusted room area value as the room area initial value.

S15: taking the current room area value as the room area actual value when a deviation result output by current estimation is different from a deviation result output by last estimation.

For example, the deviation result output by current estimation is that the current room area value is relatively large, and the deviation result output by last estimation is that the current room area value is relatively small. For another example, the deviation result output by the current estimation is that the current room area value is relatively small, and the deviation result output by last estimation is the current room area value is relatively large. In these cases, the current room area value is a room area value obtained by adjusting the room area initial value according to the deviation result of a last output.

A room area acquisition method known to the inventors is to communicate with the air conditioner outdoor unit through the air conditioner indoor unit, and the air conditioner indoor unit directly sends indoor area information to the air conditioner outdoor unit, so that the outdoor unit adjusts an operation parameter to achieve stable operation. However, the inventors note that in some application scenarios, for example, manufacturers or models of an air conditioner indoor unit and an air conditioner outdoor unit are different, data communication between the air conditioner indoor unit and the air conditioner outdoor unit cannot be carried out, and the air conditioner outdoor unit cannot acquire indoor data, and can only implement startup/shutdown control depending on a startup/shutdown level signal of the outdoor unit provided by a temperature controller. In this case, since the air conditioner outdoor unit cannot acquire the indoor data and can only operate according to a fixed control mode, such as fixed power, which may cause that a power of the air conditioner outdoor unit does not match an indoor demand, there is a need to make the outdoor unit accurately acquire the room area where the indoor unit is located without communication between the indoor and the outdoor units.

In the foregoing embodiments, the room area acquisition method includes: setting a room area initial value according to an air conditioner model parameter; acquiring a stable operation duration and a number of stop times of an air conditioner outdoor unit from starting up and stable operation to stopping at a temperature point; estimating a deviation between the room area initial value and a room area actual value according to the stable operation duration and the number of stop times, and outputting a deviation result, where the deviation result includes: a current room area value is relatively large or a current room area value is relatively small; adjusting the room area initial value according to the deviation result, and performing estimation again according to an adjusted room area value; and taking the current room area value as the room area actual value when a deviation result output by current estimation is different from a deviation result output by last estimation. In this way, a room area may be accurately acquired under a condition that indoor and outdoor units cannot communicate, and then an operation parameter of the outdoor unit may be adjusted according to the room area, thereby solving the problem that the power of the outdoor unit does not match the indoor demand, improving the user experience and an operation stability of the outdoor unit.

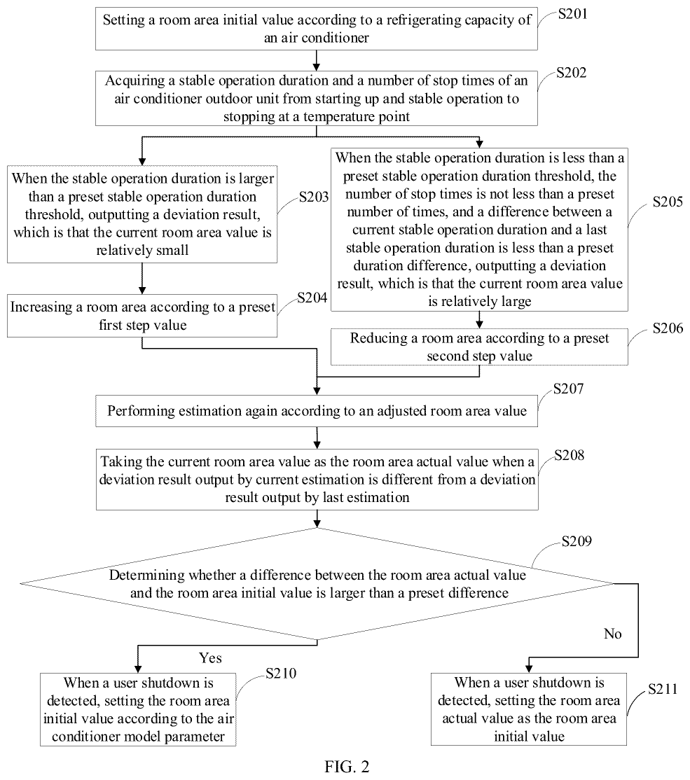

FIG. 2 is a flowchart of a room area acquisition method according to some other embodiments of the present disclosure. As shown in FIG. 2, in some embodiments, the room area acquisition method includes steps S201, S202, S203, S207, and S208. In some other embodiments, the room area acquisition method includes steps S201, S202, S203, S204, S207, and S208. In yet some other embodiments, the room area acquisition method includes steps S201, S202, S205, S207, and S208. In yet some other embodiments, the room area acquisition method includes steps S201, S202, S205, S206, S207, and S208. In yet some other embodiments, the room area acquisition method includes steps S201, S202, S203, S204, S205, S206, S207, and S208.

S201: setting a room area initial value according to a refrigerating capacity of an air conditioner.

For example, if the refrigerating capacity of the air conditioner is 1.5 hp, the room area initial value is set to be 20 square meters.

S202: acquiring a stable operation duration and a number of stop times of an air conditioner outdoor unit from starting up and stable operation to stopping at a temperature point.

In some embodiments, the step of acquiring the stable operation duration of the air conditioner outdoor unit from starting up and stable operation to stopping at the temperature point includes:
acquiring a first time point at which the stable operation is reached after the air conditioner outdoor unit is started up;
acquiring a second time point at which a stop signal is received after the stable operation of the air conditioner outdoor unit; and
taking a time difference between the second time point and the first time point as the stable operation duration of the air conditioner outdoor unit from starting up and stable operation to stopping at the temperature point.

In some embodiments, the room area acquisition method further includes:
determining that a startup-shutdown control is abnormal when a number of times of receiving the stop signal within a preset time exceeds a preset number of times threshold.

In some application scenarios, a temperature controller is abnormal or startup-shutdown is frequently controlled. If the room area is estimated by using the method of the present disclosure, and a deviation result output by each round is that the room area is relatively large, the room area needs to be continuously reduced, and finally, the output room area actual value is relatively small. Since a power adjustment of the outdoor unit corresponds to the room area actual value, when the outdoor unit is started up again, the indoor cooling/heating effect is poor, which affects the user experience.

In some embodiments of the present disclosure, the above case may be effectively avoided by determining whether the startup-shutdown control is abnormal. For example, if it is detected that the startup/shutdown signal is received for more than three times within 5 min, it is determined that the startup-shutdown control is abnormal, and in this case, an initialized room area is the room area initial value, so as to ensure that an estimated room area actual value is not too small because of the abnormal startup-shutdown control after the outdoor unit is started up, which results in the fact that a startup power is too low.

S203: when the stable operation duration is larger than a preset stable operation duration threshold, outputting a deviation result, which is that the current room area value is relatively small.

In some embodiments of the present disclosure, the preset stable operation duration threshold is 1 hour.

S204: increasing a room area according to a preset first step value.

In some embodiments of the present disclosure, a first step value is 1 square meter.

In some embodiments, when the room area is increased to reach a preset room area upper limit value, the deviation result output is that the current room area value is relatively small, and the room area upper limit value is taken as the room area actual value.

The upper limit value corresponds to a maximum power of the outdoor unit, and due to the limit of the upper limit value, the room area cannot be increased to an actual room size. It is indicated that even if the outdoor unit operates at a full power, the indoor demand cannot be met, and in this case, the outdoor unit is controlled to keep operation at the maximum power.

S205: when the stable operation duration is less than a preset stable operation duration threshold, the number of stop times is not less than a preset number of times, and a difference between a current stable operation duration and a last stable operation duration is less than a preset duration difference, outputting a deviation result, which is that the current room area value is relatively large.

In some embodiments of the present disclosure, the preset stable operation duration threshold is 1 hour, the preset number of times is three, and the preset duration difference is 3 minutes.

S206: reducing a room area according to a preset second step value.

In some embodiments of the present disclosure, a second step value is 1 square meter.

In some embodiments, when the room area is reduced to reach a preset room area lower limit value, the deviation result output is that the current room area value is relatively large, and the room area lower limit value is taken as the room area actual value.

The lower limit value corresponds to a minimum power of the outdoor unit, and due to the limit of the lower limit value, the room area cannot be reduced to an actual room area size. It is indicated that a power of type selection of the outdoor unit is too large, the performance is excessive, and the outdoor unit is controlled to operate at the minimum power for keeping the unit stable and reliable.

S207: performing estimation again according to an adjusted room area value.

S208: taking the current room area value as the room area actual value when a deviation result output by current estimation is different from a deviation result output by last estimation.

After multi-round adjustments, the room area value reaches the actual room size, and at this time, the power of the outdoor unit matches the indoor demand.

In some embodiments, the room area acquisition method further includes step S209 to step S211.

S209: determining whether a difference between the room area actual value and the room area initial value is larger than a preset difference (a preset area difference), if yes, S210 is performed, otherwise, S211 is performed.

S210: when a user shutdown is detected, setting the room area initial value according to the air conditioner model parameter.

S211: when a user shutdown is detected, setting the room area actual value as the room area initial value.

In some embodiments, a method for detecting the user shutdown includes but is not limited to the following manners:

Manner 1: a duration of the stop exceeds a preset time (for example, 1 hour), but a startup signal is not received. If the duration of the stop for more than 1 hour in a refrigeration mode, the room may certainly get hot, and the temperature controller may certainly send an instruction for startup control, and therefore, if the startup signal is not received for more than 1 hour, it is considered to be a manual shutdown, and a heating mode is the same.

Manner 2: a shutdown signal sent by the temperature controller is received.

In some embodiments, the method for detecting the user shutdown includes one or more of manner 1 and manner 2.

Considering that an operation of the outdoor unit is to be able to realize a rapid cooling or heating of a room, a change in an indoor power demand is affected by factors such as season, climate and the like if the outdoor unit has not been started up for a long time. Therefore, if the room area actual value estimated in this time is smaller than the room area initial value by a prese value (for example, 3 square meters), the initial value is reset to the room area initial value when a user shutdown is detected, so as to ensure that the user experience is not affected because the startup power is too low.

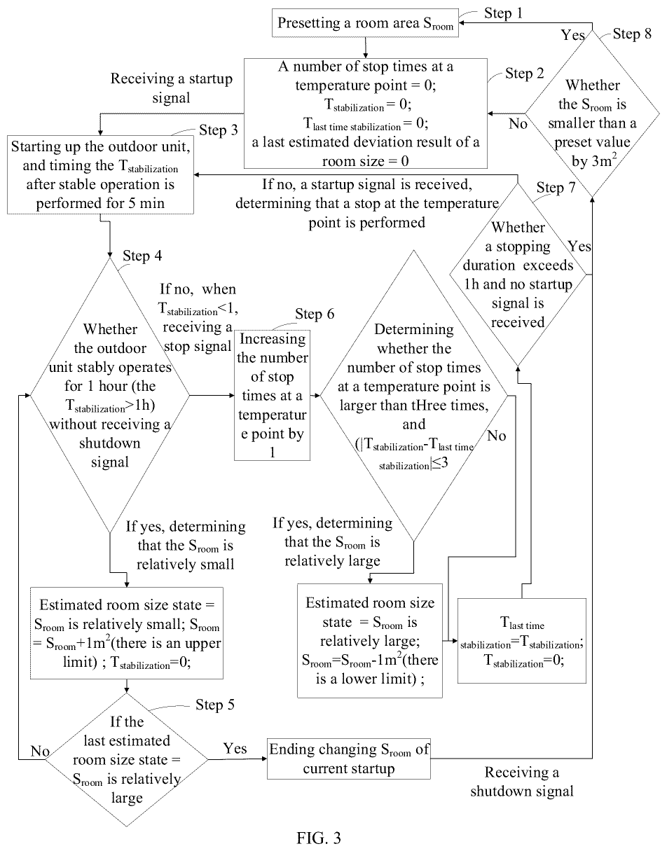

In some embodiments, as shown in FIG. 3, a specific process of acquiring a room area includes the following steps.

Step 1: powering on a unit, and presetting a room area Sᵣₒₒₘ according to a type of the unit.

Step 2: performing data initialization, where, for example, a number of stop times at a temperature point is equal to 0, a current stable operation duration T_{stabilization} is equal to 0, a last stable operation duration T_{last time stabilization} is equal to 0, and a last estimated deviation result of a room size is equal to 0; and entering a standby state, and continuously detecting whether there is a startup signal.

Step 3: starting up the unit after an outdoor unit receives the startup signal, and timing the T_{stabilization} after stable operation is performed for a period of time (for example, 5 min).

Step 4: continuously detecting whether there is a shutdown signal, determining that the Sᵣₒₒₘ is relatively small when the outdoor unit stably operates for 1 hour (the T_{stabilization}>1 h) without receiving a shutdown signal, recording an estimated room size state to be small, and then adding 1 m² to the Sᵣₒₒₘ and re-timing the T_{stabilization}.

Step 5: determining that an estimation of the room size is completed if a last estimated room size state is relatively large, keeping a current state of S′ᵣₒₒₘ to operate until a shutdown signal is received, and then executing the Step 8; otherwise, re-executing the Step 4.

Step 6: increasing the number of stop times at a temperature point by 1 if the shutdown signal is received when the stable operation duration of the outdoor unit is less than 1 hour (T_{stabilization}<1 h), then determining whether the number of stop times at a temperature point is larger than three times, and whether the stable operation duration is close to the last stable operation duration (|T_{stabilization}−T_{last time stabilization}|≤3 min). If yes, determining that the Sᵣₒₒₘ is relatively large, recording the estimated room size state to be large, and then reducing the Sᵣₒₒₘ by 1 m².

Step 7: recording the current stable operation duration then performing shutdown, and then determining a stopping duration. If the startup signal is received with a condition that the stopping duration does not exceed 1 h, determining that a stop at the temperature point is performed, storing a data, and then executing Step 2.

Step 8: determining whether the S′ᵣₒₒₘ is smaller than the room area Sᵣₒₒₘ preset according to the type of the unit by 3 m², if yes, executing Step 1; otherwise, executing Step 2.

If the stopping duration exceeds 1 h, it is determined that it is a user shutdown.

Some embodiments of the present disclosure may implement that a frequency of a compressor is increased after a long-time stable operation and the stable operation may be kept all the time under a condition that a non-communication outdoor unit is continuously provided with a startup signal by the temperature controller. Through multi-round estimations, after the non-communication outdoor unit receives stop signals for multiple times within a certain period of time, the non-communication outdoor unit is started up again until the frequency of the compressor is stable, and a stable operation frequency of the compressor is reduced. In addition, after the frequency of the compressor is adjusted by an algorithm, startup and shutdown signals are frequently received in a short time from the temperature controller, it is determined that the startup-shutdown control is abnormal, and the frequency of the compressor is restored to a value corresponding the initial area.

In some embodiments of the present disclosure, when there is no direct data interaction between the indoor and outdoor units of the air conditioner, an operation parameter of the outdoor unit may be automatically adjusted to adapt an indoor demand, an indoor temperature adjustment effect is optimized, the user experience is improved, a problem of over-adjustment or under-adjustment of the indoor temperature adjustment caused by lack of data interaction between the indoor and outdoor units is avoided, and a better energy-saving effect may also be achieved. In addition, the number of stop times during a normal operation process of the outdoor unit may be reduced, an operation of the air conditioner outdoor unit is more stable, and a service life of the air conditioner is prolonged.

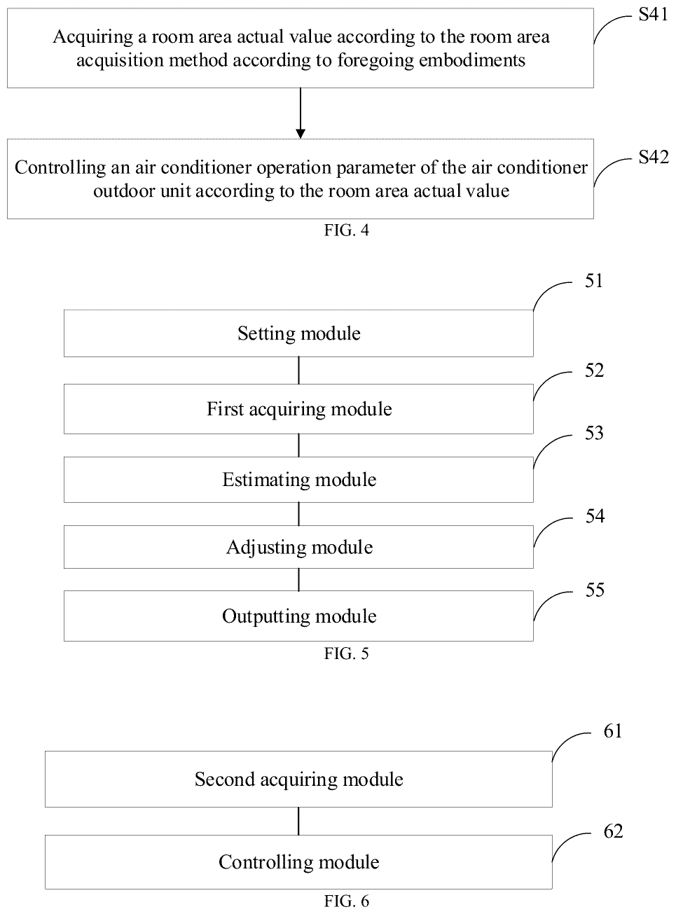

FIG. 4 is a flowchart of an air conditioner outdoor unit control method according to some embodiments of the present disclosure, and as shown in FIG. 4, the air conditioner outdoor unit control method includes steps S41 and S42.

S41: acquiring a room area actual value according to the room area acquisition method according to foregoing embodiments.

S42: controlling an air conditioner operation parameter of the air conditioner outdoor unit according to the room area actual value.

In some embodiments of the present disclosure, the air conditioner operation parameter includes, but is not limited to, a frequency of a compressor, a rotational speed of an external fan, or the like.

In some embodiments, the controlling an air conditioner operation parameter of the air conditioner outdoor unit according to the room area actual value may be implemented by below method: presetting a look-up table of the room area and the air conditioner operation parameter, then acquiring the air conditioner operation parameter through the look-up table to control the stable operation of the air conditioner outdoor unit.

It should be noted that the air conditioner outdoor unit control method is not limited in the present disclosure, and air conditioner outdoor unit control method according to the present disclosure is applicable to other application scenarios for controlling the air conditioner outdoor unit according to the room area.

A room area acquisition method known to the inventors is to communicate with the air conditioner outdoor unit through the air conditioner indoor unit, and the air conditioner indoor unit directly sends indoor area information to the air conditioner outdoor unit, so that the outdoor unit adjusts an operation parameter to achieve stable operation. However, in some application scenarios, for example, manufacturers or models of an air conditioner indoor unit and an air conditioner outdoor unit are different, data communication between the air conditioner indoor unit and the air conditioner outdoor unit cannot be carried out, and the air conditioner outdoor unit cannot acquire indoor data, and can only implement startup/shutdown control depending on a startup/shutdown level signal of the outdoor unit provided by a temperature controller. In this case, since the air conditioner outdoor unit cannot acquire the indoor data and can only operate according to a fixed control mode, such as fixed power, which may cause that a power of the air conditioner outdoor unit does not match an indoor demand.

In the embodiments of the present disclosure, a room area actual value is the acquired according to the room area acquisition method according to foregoing embodiments, an air conditioner operation parameter of the air conditioner outdoor unit is controlled according to the room area actual value, and the operation parameter of the outdoor unit may be adjusted automatically to adapt the indoor demand under a condition that there is no direct data interaction between the indoor and outdoor units of the air conditioner, thereby improving the user experience and improving the operation stability of the outdoor unit.

An embodiment of the present disclosure provides a room area acquisition apparatus, and as shown in a functional structural diagram in FIG. 5, the room area acquisition includes:
a setting module 51 configured to set a room area initial value according to an air conditioner model parameter;
a first acquiring module 52 configured to acquire a stable operation duration and a number of stop times of an air conditioner outdoor unit from starting up and stable operation to stopping at a temperature point;
an estimating module 53 configured to estimate a deviation between the room area initial value and a room area actual value according to the stable operation duration and the number of stop times, and output a deviation result, where the deviation result includes: a current room area value is relatively large or a current room area value is relatively small;
an adjusting module 54 configured to adjust the room area initial value according to the deviation result, and perform estimation again according to an adjusted room area value; and
an outputting module 55 configured to take the current room area value as the room area actual value when a deviation result output by current estimation is different from a deviation result output by last estimation.

In the embodiment of the present disclosure, the setting module sets a room area initial value according to an air conditioner model parameter; the first acquiring module acquires a stable operation duration and a number of stop times of an air conditioner outdoor unit from starting up and stable operation to stopping at a temperature point; the estimating module estimates a deviation between the room area initial value and a room area actual value according to the stable operation duration and the number of stop times, and outputs a deviation result, where the deviation result includes: a current room area value is relatively large or a current room area value is relatively small; the adjusting module adjusts the room area initial value according to the deviation result, and performs estimation again according to an adjusted room area value; and the outputting module takes the current room area value as the room area actual value when a deviation result output by current estimation is different from a deviation result output by last estimation. In this way, a room area may be accurately acquired under a condition that indoor and outdoor units cannot communicate, and then an operation parameter of the outdoor unit may be adjusted according to the room area, thereby solving a problem that a power of the outdoor unit does not match an indoor demand, improving the user experience and an operation stability of the outdoor unit.

In some embodiments, the room area acquisition apparatus may further include other modules to perform the room area acquisition method in the foregoing other embodiments.

Embodiments of the present disclosure further provide another room area acquisition apparatus, which includes: a memory; and a processor coupled to the memory and configured to perform the room area acquisition method according to any one of the foregoing embodiments based on instructions stored in the memory.

Embodiments of the present disclosure provide an air conditioner outdoor unit control apparatus, and as shown in a functional structural diagram in FIG. 6, the air conditioner outdoor unit control apparatus includes:
a second acquiring module 61 configured to acquire a room area actual value according to the room area acquisition method according to foregoing embodiments; and
a controlling module 62 configured to control an air conditioner operation parameter of the air conditioner outdoor unit according to the room area actual value.

In the embodiments of the present disclosure, a room area actual value is acquired through the second acquiring module according to the room area acquisition method according to foregoing embodiments, and an air conditioner operation parameter of the air conditioner outdoor unit is controlled through the controlling module according to the room area actual value, so that the operation parameter of the outdoor unit may be adjusted automatically to adapt the indoor demand under a condition that there is no direct data interaction between the indoor and outdoor units of the air conditioner, thereby improving the user experience and improving the operation stability of the outdoor unit.

In some embodiments, the air conditioner outdoor unit control apparatus includes the room area acquisition apparatus according to any one of the foregoing embodiments, for example, includes the room area acquisition apparatus shown in FIG. 5.

In some embodiments, the air conditioner outdoor unit control apparatus may further include other modules to perform the air conditioner outdoor unit control method in the foregoing other embodiments.

Embodiments of the present disclosure further provide another air conditioner outdoor unit control apparatus, which includes: a memory; and a processor coupled to the memory and configured to perform the air conditioner outdoor unit control method according to any one of the foregoing embodiments based on instructions stored in the memory.

An embodiment of the present disclosure provides an air conditioner outdoor unit, which includes:
the room area acquisition apparatus according to any one of the foregoing embodiments and/or the air conditioner outdoor unit control apparatus according to any one of the foregoing embodiments. In some embodiments, the air conditioner outdoor unit includes the room area acquisition apparatus according to any one of the foregoing embodiments. In some other embodiments, the air conditioner outdoor unit includes the air conditioner outdoor unit control apparatus according to any one of the foregoing embodiments. In yet some other embodiments, the air conditioner outdoor unit includes the room area acquisition apparatus according to any one of the foregoing embodiments and the air conditioner outdoor unit control apparatus according to any one of the foregoing embodiments.

An embodiment of the present disclosure provides an air conditioning system, which includes:
the air conditioner outdoor unit according to any one of the foregoing embodiments, a temperature controller, and an air conditioner indoor unit.

The temperature controller is configured to control the air conditioner outdoor unit to start up and shut down; and
the air conditioner outdoor unit is configured to drive the air conditioner indoor unit to perform cooling or heating on a room where the air conditioner indoor unit is located.

The temperature controller is a device capable of detecting indoor room temperature and providing startup/shutdown instructions (signals) to the indoor and outdoor units of the air conditioner, and does not have a data interaction function. The air conditioner outdoor unit is configured to receive a startup/shutdown signal and a cooling/heating mode signal of the temperature controller, and perform a corresponding operation.

There is no data interaction between the indoor unit and the outdoor unit of the air conditioner, the solutions of the embodiments of the present disclosure are applied to control of the outdoor unit, both the startup signal and the shutdown signal refer to signals sent by the temperature controller and detected by a signal detection module of the air conditioner outdoor unit, and the startup signal and the shutdown signal are only used to control the outdoor unit to startup/shutdown, and cannot carry data information.

In the embodiments of the present disclosure, the room area where the air conditioner indoor unit is located is estimated by the air conditioner outdoor unit itself, and the operation is adjusted according to the room area to implement stable operation of the air conditioner outdoor unit, thereby improving the user experience.

An embodiment of the present disclosure further provides a computer-readable storage medium, which includes computer program instructions, where when the computer program instructions are executed by a processor, the method according to any one of the foregoing embodiments is implemented.

An embodiment of the present disclosure further provides a computer program product, which includes a computer program, where when the computer program is executed by a processor, the method according to any one of the foregoing embodiments is implemented.

It may be understood that the same or similar parts in the foregoing embodiments may refer to each other, and the content that is not described in detail in some embodiments may refer to the same or similar content in other embodiments.

It should be noted that, in the description of the present disclosure, the terms “first”, “second”, and the like are used for descriptive purposes only and cannot be understood as indicating or implying relative importance. In addition, in the description of the present disclosure, unless otherwise specified, “a plurality of” means at least two.

Any process or method description in the flowchart or in other description manners herein may be understood as a module, segment, or portion of code that includes one or more executable instructions for implementing the steps of a specific logical function or process. The scope of some embodiments of the present disclosure includes additional implementations, which may not be performed in the order shown or discussed herein, and includes that the functions may be performed in a substantially simultaneous manner or in a reverse order depending on the functionality involved, which should be understood by those skilled in the art to which embodiments of the present disclosure belong.

It should be understood that each part of the present disclosure may be implemented by hardware, software, firmware, or a combination thereof. In the above embodiments, a plurality of steps or methods may be implemented by software or firmware stored in a memory and executed by a suitable instruction execution system. For example, if it is implemented in hardware, similarly in another embodiment, it is may be implemented by any of the following techniques in the art, or a combination thereof: discrete logic circuits having logic gate circuits for implementing logic functions on data signals, application specific integrated circuits having suitable combinational logic gate circuits, Programmable Gate Arrays (PGA), Field Programmable Gate Arrays (FPGAs), and the like.

Those of ordinary skill in the art may understand that all or some of the steps carried in the method in the foregoing embodiments may be implemented by a hardware related to a program instruction, the program may be stored in a computer-readable storage medium, and when the program is executed, one of the steps of the method embodiments or a combination thereof is included.

In addition, functional units in the embodiments of the present disclosure may be integrated into one processing module, or each of the units may exist alone physically, or two or more units are integrated into one module. The integrated module may be implemented in a form of hardware (for example, a processor), or may be implemented in a form of a software functional module. When the integrated module is implemented in the form of a software functional module and sold or used as an independent product, the integrated module may also be stored in a computer-readable storage medium.

The storage medium mentioned above may be a read-only memory, a magnetic disk, an optical disk, or the like.

In the description of this specification, reference terms “one embodiment”, “some embodiments”, “an example”, “a specific example”, or “some examples” means that a specific feature, structure, material, or characteristic described in connection with the embodiment or example is included in at least one embodiment or example of the present disclosure. In this specification, the schematic representation of the above terms does not necessarily refer to the same embodiment or example. Furthermore, the specific feature, structure, material, or characteristic may be combined in any suitable manner in one or more embodiments or examples.

Although the embodiments of the present disclosure have been shown and described above, it may be understood that the above embodiments are exemplary and cannot be understood as limitations to the present disclosure, and those skilled in the art can make changes, modifications, substitutions and variations to the above embodiments within the scope of the present disclosure.

It should be noted that the present disclosure is not limited to the above-mentioned preferred embodiments, and those skilled in the art can obtain other various forms of products under the motivation of the present disclosure, but regardless of any changes in shape or structure thereof, any technical solution that is the same as or similar to the present disclosure, falls within the protection scope of the present disclosure.

What is claimed is:

1. A room area acquisition method, comprising:
setting a room area initial value according to an air conditioner model parameter;
acquiring a stable operation duration and a number of stop times of an air conditioner outdoor unit from starting up and stable operation to stopping at a temperature point;
estimating a deviation between the room area initial value and a room area actual value according to the stable operation duration and the number of stop times, and outputting a deviation result, wherein the deviation result comprises: a current room area value is relatively large or a current room area value is relatively small;
adjusting the room area initial value according to the deviation result, and performing estimation again according to an adjusted room area value; and
taking the current room area value as the room area actual value when a deviation result output by current estimation is different from a deviation result output by last estimation.

2. The room area acquisition method according to claim 1, wherein when the stable operation duration is larger than a preset stable operation duration threshold, the deviation result is that the current room area value is relatively small.

3. The room area acquisition method according to claim 1, wherein when the stable operation duration is less than a preset stable operation duration threshold, the number of stop times is not less than a preset number of times, and a difference between a current stable operation duration and a last stable operation duration is less than a preset duration difference, the deviation result is that the current room area value is relatively large.

4. The room area acquisition method according to claim 1, wherein the adjusting the room area initial value according to the deviation result comprises:
increasing a room area according to a preset first step value when the deviation result is that the current room area value is relatively small.

5. The room area acquisition method according to claim 1, wherein the adjusting the room area initial value according to the deviation result comprises:
reducing a room area according to a preset second step value when the deviation result is that the current room area value is relatively large.

6. The room area acquisition method according to claim 1, further comprising:
determining whether a difference between the room area actual value and the room area initial value is larger than a preset area difference; and
in a case that the difference between the room area actual value and the room area initial value is larger than the preset area difference, when a user shutdown is detected, setting the room area initial value according to the air conditioner model parameter.

7. The room area acquisition method according to claim 6, further comprising:
in a case that the difference between the room area actual value and the room area initial value is less than or equal to the preset area difference, when a user shutdown is detected, setting the room area actual value as the room area initial value.

8. The room area acquisition method according to claim 1, wherein acquiring the stable operation duration of the air conditioner outdoor unit from starting up and stable operation to stopping at the temperature point comprises:
acquiring a first time point at which the stable operation is reached after the air conditioner outdoor unit is started up;
acquiring a second time point at which a stop signal is received after the stable operation of the air conditioner outdoor unit; and
taking a time difference between the second time point and the first time point as the stable operation duration of the air conditioner outdoor unit form starting up and stable operation to stopping at the temperature point.

9. The room area acquisition method according to claim 8, further comprising:
determining that a startup-shutdown control is abnormal when a number of times of receiving the stop signal within a preset time exceeds a preset number of times threshold.

10. The room area acquisition method according to claim 4, further comprising:
when the room area is increased to reach a preset room area upper limit value, and the deviation result is that the current room area value is relatively small, taking the room area upper limit value as the room area actual value.

11. The room area acquisition method according to claim 5, further comprising:
when the room area is reduced to reach a preset room area lower limit value, and the deviation result is that the current room area value is relatively large, taking the room area lower limit value as the room area actual value.

12. The room area acquisition method according to claim 1, wherein the air conditioner model parameter comprises a refrigerating capacity of an air conditioner.

13. The room area acquisition method according to claim 6, wherein a method for detecting the user shutdown comprises one or more of: a duration of a stop exceeds a preset time; and a shutdown signal sent by a temperature controller is received.

14. An air conditioner outdoor unit control method, comprising:
acquiring a room area actual value according to the room area acquisition method according to claim 1; and
controlling an air conditioner operation parameter of the air conditioner outdoor unit according to the room area actual value.

15. The air conditioner outdoor unit control method according to claim 14, wherein the air conditioner operation parameter comprises:
at least one of a frequency of a compressor and a rotational speed of an external fan.

16. A room area acquisition apparatus, comprising:
a memory; and
a processor coupled to the memory and configured to perform a room area acquisition method based on instructions stored in the memory,
wherein the room area acquisition method comprises:
setting a room area initial value according to an air conditioner model parameter;
acquiring a stable operation duration and a number of stop times of an air conditioner outdoor unit from starting up and stable operation to stopping at a temperature point;
estimating a deviation between the room area initial value and a room area actual value according to the stable operation duration and the number of stop times, and outputting a deviation result, wherein the deviation result comprises: a current room area value is relatively large or a current room area value is relatively small;
adjusting the room area initial value according to the deviation result, and performing estimation again according to an adjusted room area value; and
taking the current room area value as the room area actual value when a deviation result output by current estimation is different from a deviation result output by last estimation.

17. An air conditioner outdoor unit control apparatus, comprising:
a memory; and
a processor coupled to the memory and configured to perform an air conditioner outdoor unit control method based on instructions stored in the memory,
wherein the air conditioner outdoor unit control method comprises:
acquiring a room area actual value according to the room area acquisition method according to claim 1; and
controlling an air conditioner operation parameter of the air conditioner outdoor unit according to the room area actual value.

18. An air conditioner outdoor unit, comprising:
a room area acquisition apparatus; and/or,
the air conditioner outdoor unit control apparatus according to claim 17,
wherein the room area acquisition apparatus comprises:
a memory; and
a processor coupled to the memory and configured to perform a room area acquisition method based on instructions stored in the memory,
wherein the room area acquisition method comprises:
setting a room area initial value according to an air conditioner model parameter;
acquiring a stable operation duration and a number of stop times of an air conditioner outdoor unit from starting up and stable operation to stopping at a temperature point;
estimating a deviation between the room area initial value and a room area actual value according to the stable operation duration and the number of stop times, and outputting a deviation result, wherein the deviation result comprises: a current room area value is relatively large or a current room area value is relatively small;
adjusting the room area initial value according to the deviation result, and performing estimation again according to an adjusted room area value; and
taking the current room area value as the room area actual value when a deviation result output by current estimation is different from a deviation result output by last estimation.

19. An air conditioning system, comprising:
the air conditioner outdoor unit according to claim 18, a temperature controller, and an air conditioner indoor unit; wherein
the temperature controller is configured to control the air conditioner outdoor unit to start up or shut down; and
the air conditioner outdoor unit is configured to drive the air conditioner indoor unit to perform cooling or heating on a room where the air conditioner indoor unit is located.

20. A non-transitory computer-readable storage medium, comprising computer program instructions, wherein when the computer program instructions are executed by a processor, a room area acquisition method is implemented,
wherein the room area acquisition method comprises:
setting a room area initial value according to an air conditioner model parameter;
acquiring a stable operation duration and a number of stop times of an air conditioner outdoor unit from starting up and stable operation to stopping at a temperature point;
estimating a deviation between the room area initial value and a room area actual value according to the stable operation duration and the number of stop times, and outputting a deviation result, wherein the deviation result comprises: a current room area value is relatively large or a current room area value is relatively small;
adjusting the room area initial value according to the deviation result, and performing estimation again according to an adjusted room area value; and
taking the current room area value as the room area actual value when a deviation result output by current estimation is different from a deviation result output by last estimation.
